(19) United States
(12) Patent Application Publication
(10) Pub. No.: US 2025/0239637 A1
(43) Pub. Date: Jul. 24, 2025

(54) UNIFIED ASSEMBLY FOR ELECTROCHEMICAL DEVICE

(71) Applicant: HYAXIOM, INC., East Hartford, CT (US)

(72) Inventors: Jesse Marzullo, New Paltz, NY (US); Ke Gong, East Hartford, CT (US); Jonathan Odell, East Hartford, CT (US); Timothy Patterson, East Hartford, CT (US)

(21) Appl. No.: 18/415,937

(22) Filed: Jan. 18, 2024

(51) Int. Cl. H01M 8/1004; H01M 4/88; H01M 4/94

(52) U.S. Cl. CPC H01M 8/1004; H01M 4/8807; H01M 4/94

(57) ABSTRACT

A electrochemical device includes a membrane electrode assembly, a gas diffusion layer positioned on one side of the membrane electrode assembly, and a porous transport layer positioned on an opposite side of the membrane electrode assembly. A thermoplastic film is impregnated within outer peripheral edges of the gas diffusion layer and the porous transport layer to form an electrochemical assembly with a sealed outer edge. A method of forming a an electrochemical device is also disclosed.

### BACKGROUND

This disclosure relates to electrochemical devices including unified layer arrangements and methods of fabrication.

Electrolyzers are known electrochemical devices that may be configured to convert electricity and water into hydrogen and oxygen. Electrolyzers comprising proton exchange membrane water electrolyzer (PEMWE) cell assemblies provide a variety of challenges. Various layers require precise thicknesses in order to balance compressive forces in an active area as compared to a sealed edge area. Some configurations employ cell frames with compressible gaskets; however, high axial loads and high internal pressures require that the frames be constructed of relatively expensive materials. Additionally, the frames require inlet zones, such as flow channels, to communicate reactants to the active area, and dimensional tolerances for these zones and the frame thicknesses are be strictly controlled in order to maintain proper flow balance. Further, a gap between the frame and the porous transport layer (PTL) on an anode side should be managed such that high cathode pressure from an opposite side does not force the membrane electrode assembly (MEA) into the gap, which can adversely affect the membrane life and performance.

### SUMMARY

In one example implementation, an electrochemical device comprises: a membrane electrode assembly; a gas diffusion layer positioned on one side of the membrane electrode assembly; a porous transport layer positioned on an opposite side of the membrane electrode assembly; and a thermoplastic film impregnated within outer peripheral edges of the gas diffusion layer and the porous transport layer to form an electrochemical assembly with a sealed outer edge.

In a further non-limiting implementation of the foregoing electrochemical device, the sealed outer edge extends about an entirety of a periphery of the electrochemical assembly.

In a further non-limiting implementation of any of the foregoing electrochemical devices, the electrochemical assembly includes at least one reinforcement impregnated by the thermoplastic film.

In a further non-limiting implementation of any of the foregoing electrochemical devices: the at least one reinforcement is provided in the outer peripheral edge of the porous transport layer; and/or the at least one reinforcement is provided in the outer peripheral edge of the gas diffusion layer.

In a further non-limiting implementation of any of the foregoing electrochemical devices, the at least one reinforcement comprises a fibrous material.

In a further non-limiting implementation of any of the foregoing electrochemical devices, the thermoplastic film includes a plurality of support ribs that establish a plurality of flow channels.

In a further non-limiting implementation of any of the foregoing electrochemical devices, the membrane electrode assembly comprises a proton exchange membrane with a cathode catalyst between the proton exchange membrane and the gas diffusion layer, and with an anode catalyst between the proton exchange membrane and the porous transport layer.

In a further non-limiting implementation of any of the foregoing electrochemical devices, an outer peripheral edge of the proton exchange membrane is encapsulated by the thermoplastic film.

In a further non-limiting implementation of any of the foregoing electrochemical devices, a first film layer is between the gas diffusion layer and the membrane electrode assembly and a second film layer is between the porous transport layer and the membrane electrode assembly.

In a further non-limiting implementation of any of the foregoing electrochemical devices, an active area of the gas diffusion layer is thicker than a thickness of a portion of the sealed outer edge corresponding to the gas diffusion layer.

In a further non-limiting implementation of any of the foregoing electrochemical devices, a plate is attached to a side of the porous transport layer that is opposite from the membrane electrode assembly such that the plate is formed as part of the electrochemical assembly that includes the sealed outer edge.

In a further non-limiting implementation of any of the foregoing electrochemical devices, the electrochemical device is a proton exchange membrane water electrolyzer.

In one example implementation, a method of forming at least a portion of an electrochemical device comprises: positioning a gas diffusion layer on one side of a membrane electrode assembly; positioning a porous transport layer on an opposite side of the membrane electrode assembly; and impregnating outer peripheral edges of the gas diffusion layer and the porous transport layer with a thermoplastic film to form an electrochemical assembly with a sealed outer edge.

In a further non-limiting implementation of the foregoing method, the method includes providing the electrochemical assembly with at least one reinforcement, and wherein: the at least one reinforcement is provided in the outer peripheral edge of the porous transport layer, and/or the at least one reinforcement is provided in the outer peripheral edge of the gas diffusion layer.

In a further non-limiting implementation of any of the foregoing methods, the membrane electrode assembly comprises a proton exchange membrane with a cathode catalyst between the proton exchange membrane and the gas diffusion layer, and with an anode catalyst between the proton exchange membrane and the porous transport layer, the method including: encapsulating an outer peripheral edge of the proton exchange membrane with the thermoplastic film.

In a further non-limiting implementation of any of the foregoing methods, the method includes: placing a first thermoplastic film layer between the gas diffusion layer and the membrane electrode assembly; placing a second thermoplastic film layer between the porous transport layer and the membrane electrode assembly; and heating and compressing outer peripheral edges of the gas diffusion layer, membrane electrode assembly, porous transport layer, and first and second thermoplastic film layers to form the electrochemical assembly.

In a further non-limiting implementation of any of the foregoing methods, the method includes, prior to the step of heating and compressing: placing a first release film layer between a first platen and the gas diffusion layer; placing a second release film layer between a second platen and the porous transport layer; and releasing the assembly from the first platen and the second platen once the heating and compressing has been completed.

In a further non-limiting implementation of any of the foregoing methods, the method includes, placing the electrochemical assembly on one or more bi-polar plates or separator plates.

In a further non-limiting implementation of any of the foregoing methods, the method includes, forming flow ports through outer peripheral edges of the electrochemical assembly dimensioned to communicate fluid to corresponding ports in the one or more bi-polar or separator plates.

In a further non-limiting implementation of any of the foregoing methods, the method includes, forming the thermoplastic film to include a plurality of support ribs that establish a plurality of flow channels.

The present disclosure may include any one or more of the individual features disclosed above and/or below alone or in any combination thereof.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWING

FIG. 1 schematically illustrates a selected portion of an electrochemical device.

FIG. 2 is a schematic representation of a unified cell assembly according to an implementation.

FIG. 3 is a schematic representation of a bonding process/lay-up for a unified cell assembly according to an implementation.

FIG. 4 shows the unified cell assembly of FIG. 3 with a bipolar separation plate.

FIG. 5 is a schematic representation of a bonding process/lay-up for a unified cell assembly according to another implementation.

FIG. 6 is a schematic representation of a bonding process/lay-up for a unified cell assembly according to another implementation.

FIG. 7 is a schematic representation of a bonding process/lay-up for a unified cell assembly according to another implementation.

FIGS. 8-13 show various steps in forming an electrochemical assembly according to an implementation.

Like reference numbers and designations in the various drawings indicate like elements.

### DETAILED DESCRIPTION

The subject disclosure relates to components that may be suitable for an electrochemical device such as a PEMWE.

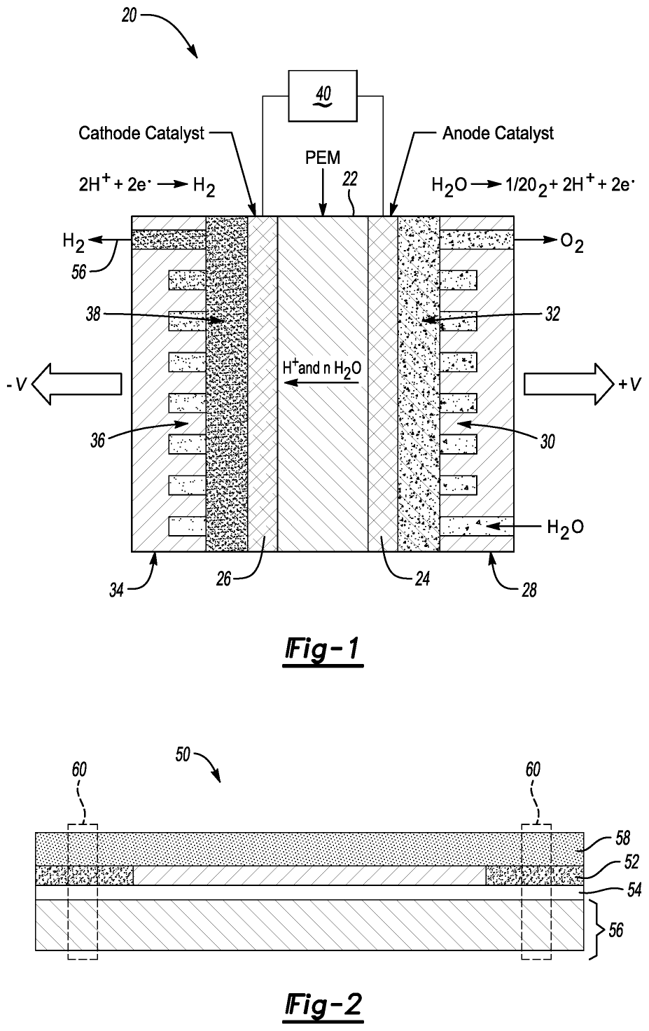

FIG. 1 schematically discloses an electrochemical device (e.g., assembly) 20 according to an implementation. The electrochemical device 20 may be an electrolyzer assembly such as a PEMWE. The operation of an electrolyzer assembly is known and it should be understood that the PEMWE is just one example of an electrolyzer, other types could also be used. The teachings disclosed herein may be utilized with other electrochemical devices, such as a fuel cell. The electrochemical device 20 may incorporate any of the features disclosed herein. In the implementation of FIG. 1, a PEM 22 is situated between an anode catalyst layer 24 and a cathode catalyst layer 26. An anode portion 28 includes an anode flowfield component 30 and an anode transport layer 32. A cathode portion 34 includes a cathode flowfield component 36 and a cathode transport layer 38. FIG. 1 shows O₂ being generated on and removed from the anode 28 and H₂ generated on and removed from a cathode 34. A power source 40 may be operable to supply current to facilitate an electrolysis reaction for producing hydrogen and oxygen, for example.

FIG. 2 discloses a unified cell assembly 50 according to an implementation. The unified cell assembly 50 may be incorporated into an electrochemical device, including any of the electrochemical devices disclosed herein. The unified cell assembly 50 may have a “unified cathode layer” (UCL) 52 positioned on one side of a bipolar separator plate 54 with an anode assembly 56 positioned on an opposite side of the bipolar separator plate 54. A membrane electrode assembly (MEA) 58 is positioned on an opposite side of the UCL 52 from the bipolar separator plate 54. Porting 60 for directing fluid flow may be established through the various layers (indicated in dashed lines).

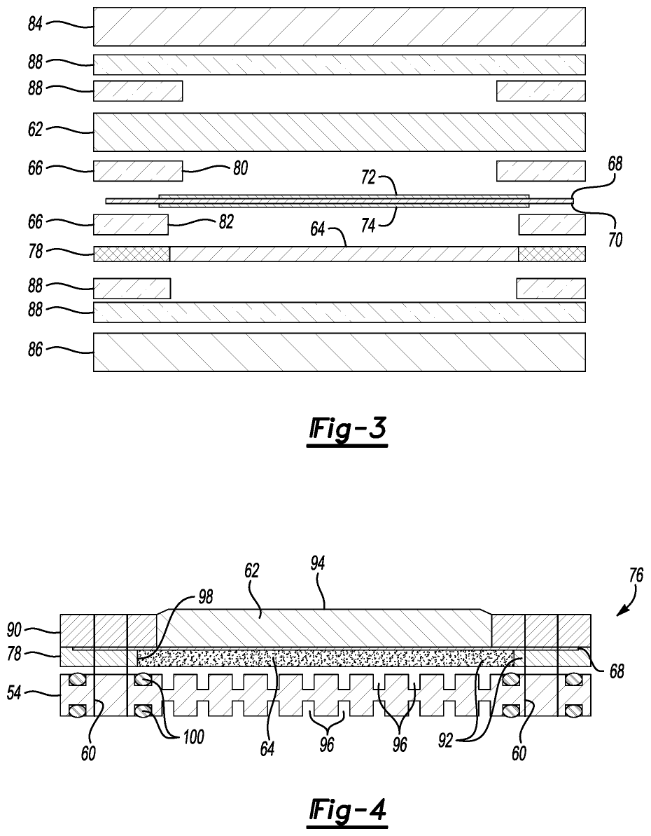

In in the implementation of FIG. 3, a gas diffusion layer (GDL) 62, the MEA 58, and a porous transport layer (PTL) 64 may be combined into one laminated structure as shown in FIG. 4. A thermoplastic bond film 66 may be used to secure layers together and establish an edge seal, which may avoid the need for a separate cell frame and active area. In implementations, the porous substrate may be impregnated or coated with an uncured material that may be cured in place. In implementations, a MEA edge 68 can be encapsulated by the established edge seal as shown in FIG. 4.

In implementations, on a cathode side of the unified cell assembly 10, the thermoplastic material may impregnate the GDL 62 to establish the UCL 52. In implementations, the GDL 62 may be a porous conductive substrate that establishes a flow field. In implementations, the thermoplastic film 66 may impregnate a reinforcement layer, such as mesh for example, along a periphery of the GDL 62. In other implementations, the thermoplastic film 66 may be hot pressed onto a substrate. The porting 60 may be cut or otherwise established through the film and substrate. Additionally, inside edges of the film may include support ribs, e.g., fingers, that establish channels to adjacent ports of the UCL 52. In implementations, this is only necessary if the cathode side of the bipolar plate does not have channels as there would be no need for fingers if the gas could flow under the UCL seal through the bipolar plate channels. This will be discussed in greater detail below.

Similarly, on an anode side of the unified cell assembly 10, thermoplastic material may impregnate the PTL 64 to establish a “unified anode layer” (UAL). In implementations, the thermoplastic film 66 may impregnate a reinforcement layer along a periphery of a porous conductive substrate of the PTL 64.

FIG. 3 shows implementations of a bonding process/lay-up method where the GDL 62, the MEA 58, and the PTL 64 are combined into one laminated structure. The MEA 58 comprises a PEM 70 with a cathode catalyst 72 on one side and an anode catalyst 74 on an opposite side. The GDL 62 is positioned on one side of the MEA 58 and the PTL 64 is positioned on an opposite side of the MEA 58. The thermoplastic film 66 is impregnated within outer peripheral edges of the GDL 62 and the PTL 64 to form an electrochemical assembly 76 with a sealed outer edge 90 as shown in FIG. 4. In implementations, the sealed outer edge 90 extends about an entirety of a periphery of the electrochemical assembly 76.

Various materials may be utilized to establish the film layer. In implementations, the film layer comprises materials that are cure-in-place, such as certain plastics (DuPont PVF “Tedlar” for example, or cross-linked polymers), UV/heat/reaction cured resins, etc. The porous substrates are impregnated or coated the with the uncured material that is then cured in place.

In implementations, the electrochemical assembly 76 includes at least one reinforcement 78 impregnated by the thermoplastic film 66. In the example shown in FIGS. 3-4, the reinforcement 78 is part of the PTL 64. The reinforcement 78 may be situated on the anode side. In implementations, the reinforcement may be provided about an entirety of the outer peripheral edge of the PTL 64. In implementations, the reinforcement 78 comprises a woven fiber material, e.g., glass or carbon fiber fabric, or other similar types of reinforcing materials. In other implementations, the reinforcement 78 comprises fibrous material such as spun fiber, loose fiber, etc.

In implementations, a first layer 80 of bond film 66 is positioned between the GDL 62 and the MEA 58 and a second layer 82 of bond film 66 is positioned between the PTL 64 and the MEA 58. In implementations, in order to form the electrochemical assembly 76, the various layers are positioned between a first, e.g. upper, platen 84 and a second, e.g. lower, platen 86. These platens 84, 86 are pressed together to form the sealed outer edge 90 of the electrochemical assembly 76. When the platens 84, 86 are pressed together, steps of heating and curing can occur in a known manner to form the sealed outer edge 90. In implementations, release film layers 88 are positioned between each platen 84, 86 and the respective GDL 62 and PTL 64 to facilitate the release of the sealed electrochemical assembly 76 from the platens 84, 86.

As shown in FIG. 4, the outer edges of the GDL 62, PTL 64, and reinforcement 78 are all impregnated with the thermoplastic material to form a unified assembly 76. The outer edge 68 of the MEA 58 may be completely encapsulated as shown. Thickness of the PTL 64 and the reinforcement area 78 are precision matched to each other as a result of the pressing process as indicated at 92. Additionally, there is no gap between the reinforcement 78 and PTL 64 as indicated at 98. As the assembly 76 has a sealed outer peripheral edge 90, an open, active center area 94 of the GDL 62 is provided as indicated at 94. In implementations, a thickness of the active center area 94 of the GDL 62 may be thicker than the sealed outer edge portion of the GDL 62.

The electrochemical assembly 76 can then be placed on one side of the bipolar separation plate 54. Another electrochemical assembly 76 may be placed on an opposite side of the bipolar separation plate 54. Another, bipolar separation plate 54 may then be stacked on that electrochemical assembly 76, and the stacking of plates 54 and assemblies 76 can be continued until a desired number of assemblies 76 are provided. Porting 60 through the plate 54 and the assembly 76 can be used to direct fluid flow. Porting 96 may be provided in the bipolar separation plate 54. Seals 100 can be installed in the bipolar separation plate 54 to prevent or otherwise reduce a likelihood of leakage from the porting 60, 96.

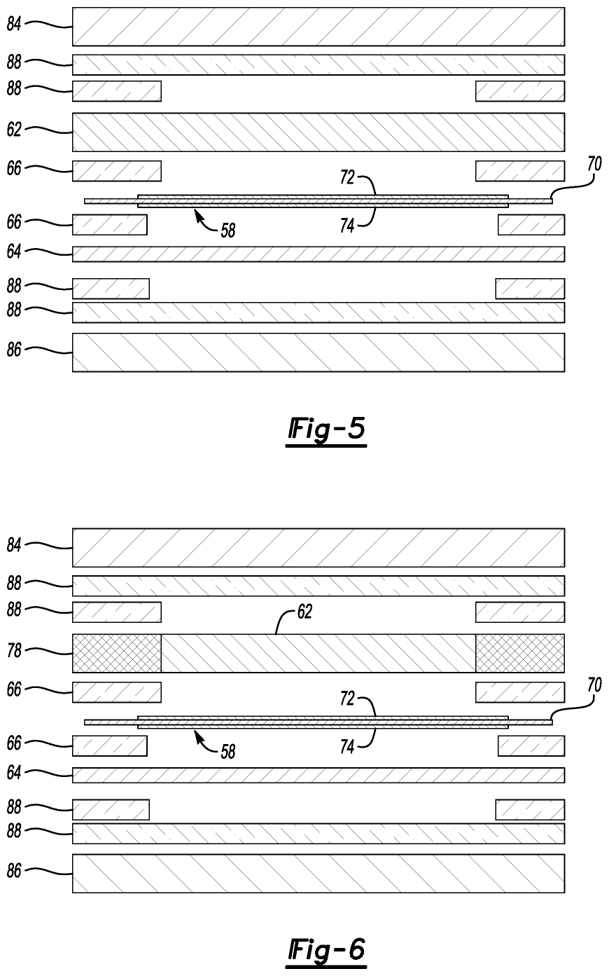

FIG. 5 shows an implementation similar to that of FIG. 4 except that in the assembly of FIG. 5 there is no reinforcement 78. The reinforcing mesh material may be omitted. The outer peripheral edge of the PTL 64 may be directly edge sealed during the pressing process.

FIG. 6 shows an implementation similar to that of FIG. 4 except that in the assembly of FIG. 6, the reinforcement 78 is provided in the outer peripheral edge of the GDL 62. The reinforcement 78 may be positioned on the cathode side.

In any of the configurations disclosed herein, the electrode coatings for the cathode catalyst 72 and anode catalyst 74 may extend farther outward toward the peripheral edges of the sealed edge area (compare FIGS. 5 and 6, for example).

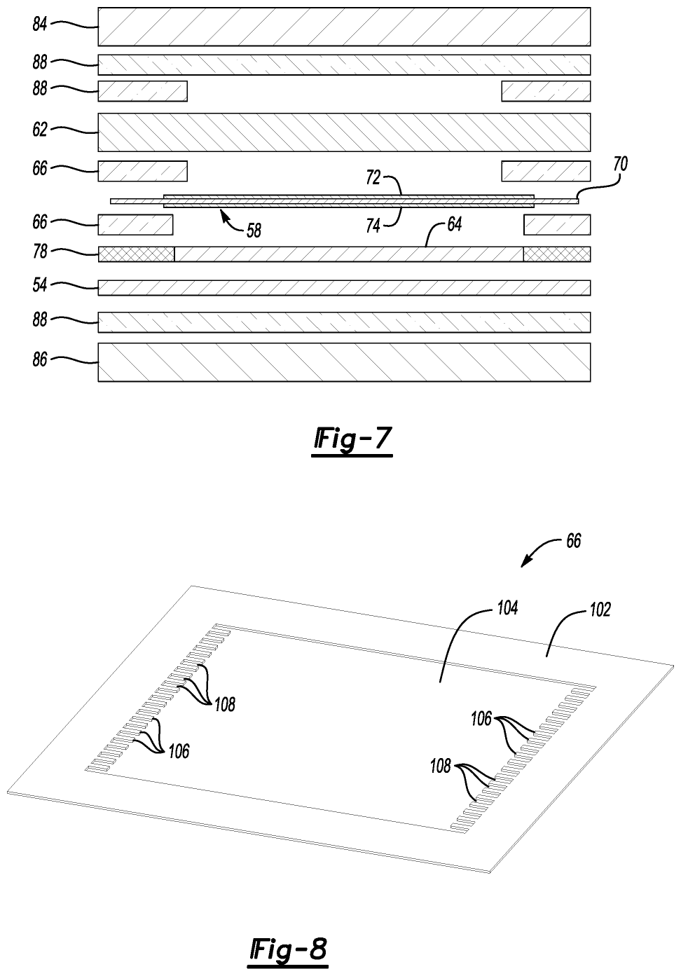

FIG. 7 shows an implementation similar to that of FIG. 4 except that in the assembly of FIG. 7, the bipolar separation plate 54, or a separator plate with porting on only one side, is attached to a side of the PTL 64 that is opposite from the MEA 58, such that the plate 54 is formed as part of the assembly 76 that includes the sealed outer edge 90. The plate 54 may or may not be previously sintered to the PTL 64.

FIGS. 8-13 show various steps in forming the electrochemical assembly 76 with the sealed outer edge 90 according to an implementation. FIG. 8 shows an example of a bond film layer 66 formed as a “frame”. The bond film layer 66 can be comprised of PEEK, PPS, HDPE, PVDF, PTFE, or other similar materials, for example. The film layer 66 has an outer peripheral edge 102 with an open center area 104. In implementations, one or more edges of the film layer 66 defining the open center area 104 can include a plurality of support ribs 106 that establish a plurality of flow channels 108.

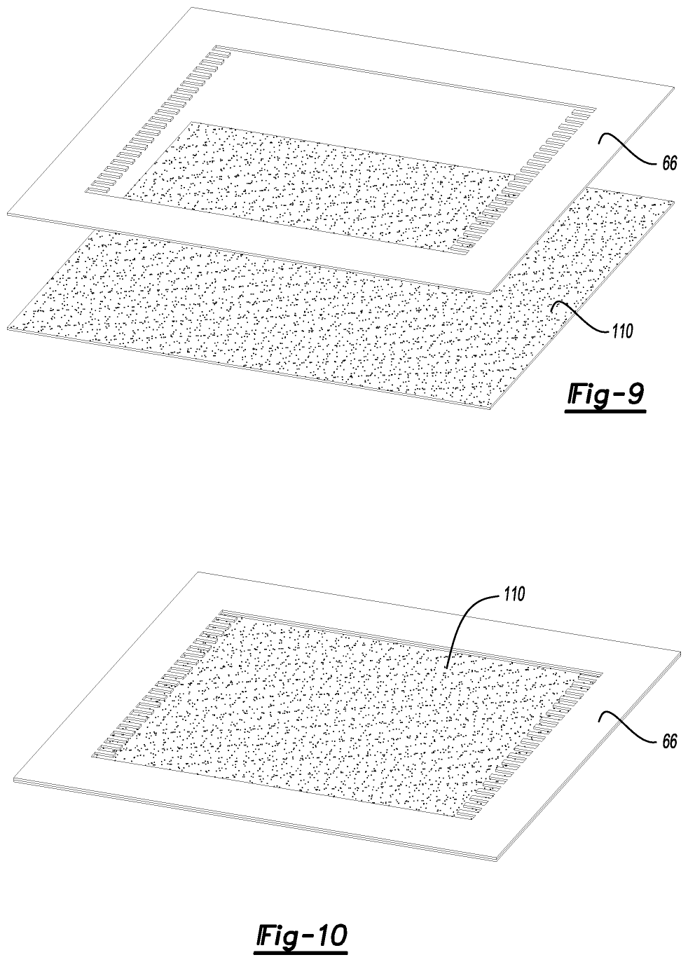

FIG. 9 shows the film layer 66 being applied over a flow substrate 110, e.g. GDL and/or PTL porous substrate material. FIG. 10 shows the film layer 66 as hot pressed into the substrate 110. In implementations, the flow field can be constructed of a porous conductive substrate material of metal, carbon, etc.

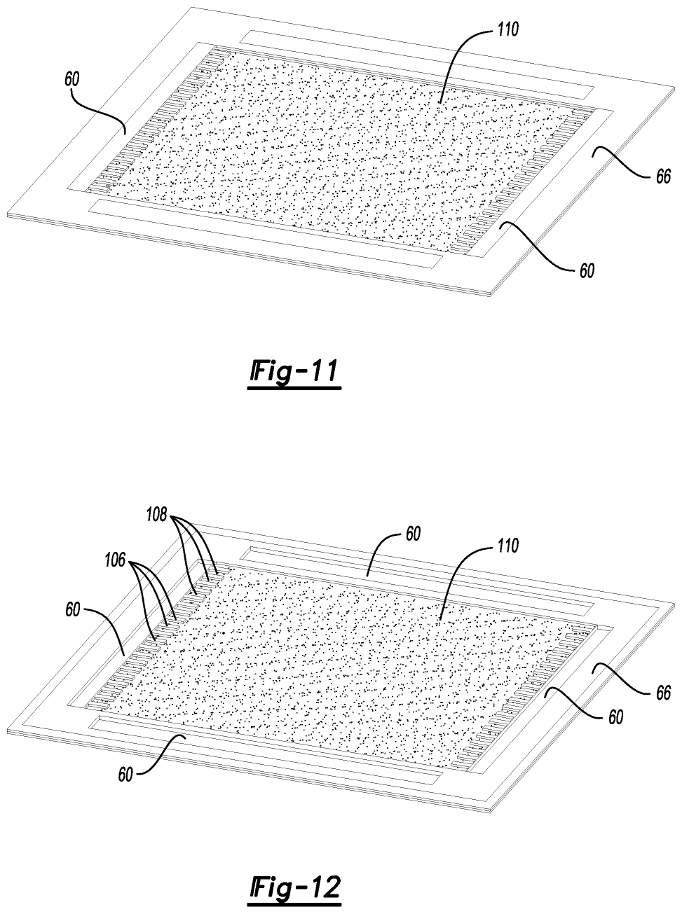

FIG. 11 shows implementations of porting 60 that can be cut or otherwise established through the layers 66, 110 to create a support zone and flow zones if needed.

FIG. 12 shows a (e.g., final) integrated assembly of UCL 52 with support zones or ribs 106, flow zones or channels 108, and porting 60. Thus, rather than having a separate frame and flow field assembly, the seal/frame and flow area are integrated into one unified assembly. The unified assembly may be established such that there may be no gaps between the seal and active area, very thin “frames” may be provided, and the seal area may be mechanically reinforced by the substrate, which may enable the use of less expensive plastics/materials.

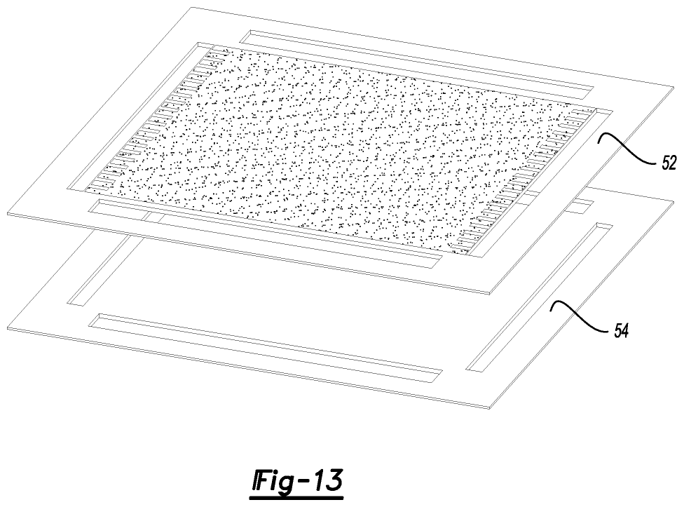

FIG. 13 shows the UCL 52 being axially loaded onto a separator plate 54. The MEA 58 may be placed on top of the UCL 52.

In implementations, a method of forming at least a portion of an electrochemical device may include: positioning a GDL 62 on one side of a MEA 58; positioning a PTL 64 on an opposite side of the MEA 58; and/or impregnating outer peripheral edges of the a GDL 62 and the PTL 64 with a thermoplastic film 66 to form an electrochemical assembly 76 with a sealed outer edge 90.

The method may further include any of the additional steps either alone or in any combination thereof.

In implementations, the method may include providing the electrochemical assembly with at least one reinforcement 78. The at least one reinforcement 78 may be provided in the outer peripheral edge of the PTL 64, and/or the at least one reinforcement may be provided in the outer peripheral edge of the GDL 62.

In implementations, the MEA 58 comprises a PEM 70 with a cathode catalyst 72 between the PEM 70 and the GDL 62, and with an anode catalyst between the PEM 70 and the PTL 64. The method may include encapsulating an outer peripheral edge of the PEM 70 with the thermoplastic film.

In implementations, the method may include: placing a first thermoplastic film layer 66 between the GDL 62 and the MEA 58; placing a second thermoplastic film layer 66 between the PTL 64 and the MEA 58; and/or heating and compressing outer peripheral edges of the GDL 62, MEA 58, PTL 64, and first and second thermoplastic film layers 66 to form the electrochemical assembly 76.

In implementations, the method may include, prior to the step of heating and compressing: placing a first release film layer 88 between a first platen 84 and the GDL 62; placing a second release film layer 88 between a second platen 86 and the PTL 64; and/or releasing the electrochemical assembly 76 from the first platen 84 and the second platen 86 once the heating and compressing has been completed.

In implementations, the method may include placing the electrochemical assembly 76 on one or more bi-polar plates or separator plates 54.

In implementations, the method may include forming flow ports 60 through outer peripheral edges of the electrochemical assembly 76. The flow ports 60 may be dimensioned to communicate fluid to corresponding ports 96 in the one or more bi-polar or separator plates 54.

In implementations, the method may include forming the thermoplastic film 66 to include a plurality of support ribs 106. The support ribs 106 may establish a plurality of flow channels 108.

The subject disclosure provides for the GDL 62, MEA 58, and PTL 64 being combined into one laminated structure that may eliminate having separate components for cell frames and active area components. Further, low cost materials such as LDPE, for example, can be employed as an edge seal, while being reinforced with such materials as the carbon fibers of the cathode GDL themselves, or perhaps being reinforced with a plastic or fiberglass mesh. The cost of these materials may be substantially lower than the bulk equivalents (carbon fiber composites or glass filled PEEK/PPS/PSU frames). Also, the lamination process can be well controlled such that no gap may exist at the PTL/edge seal boundary, which may fully support the MEA 58 from cross-pressure related issues. Further, as the bond film layers are melted and extruded, dimensional tolerance of the seal material versus active area sheet thickness is relaxed and they can be “fit to shape” during the process.

Certain situations/conditions may occur where impregnating the entire seal area may restrict or block the outlet flow region for hydrogen and water (e.g., primarily if cathode channels are omitted from the bipolar plate), or if the film is left out entirely between the flow area and a port, the substrate may not provide adequate mechanical support for the opposing anode assembly and seal. In this case, the impregnation film may include “fingers” which create a “rib and channel” structure over the exits. The specific geometries are configured such that the ribs/channels provide adequate mechanical support for the opposing seal, and such that there is a sufficient open flow area for H₂ and water.

The disclosed techniques may be utilized to establish a component having a cross-flow arrangement that may be incorporated into an electrochemical device. The component may be a conductive bipolar plate that may be stamped or otherwise formed in a manner that may facilitate cross-flow on opposite sides of the plate. The plate may be formed in a manner that may reduce manufacturing complexity and cost.

The preceding description is illustrative rather than limiting in nature. Variations and modifications to the disclosed examples may become apparent to those skilled in the art that do not necessarily depart from the essence of this invention.

What is claimed:

1. An electrochemical device comprising:
a membrane electrode assembly;
a gas diffusion layer positioned on one side of the membrane electrode assembly;
a porous transport layer positioned on an opposite side of the membrane electrode assembly; and
a thermoplastic film impregnated within outer peripheral edges of the gas diffusion layer and the porous transport layer to form an electrochemical assembly with a sealed outer edge.

2. The electrochemical device as recited in claim 1, wherein the sealed outer edge extends about an entirety of a periphery of the electrochemical assembly.

3. The electrochemical device as recited in claim 1, wherein the electrochemical assembly includes at least one reinforcement impregnated by the thermoplastic film.

4. The electrochemical device as recited in claim 3, wherein:
the at least one reinforcement is provided in the outer peripheral edge of the porous transport layer; and/or
the at least one reinforcement is provided in the outer peripheral edge of the gas diffusion layer.

5. The electrochemical device as recited in claim 3, wherein the at least one reinforcement comprises a fibrous material.

6. The electrochemical device as recited in claim 1, wherein the thermoplastic film includes a plurality of support ribs that establish a plurality of flow channels.

7. The electrochemical device as recited in claim 1, wherein the membrane electrode assembly comprises a proton exchange membrane with a cathode catalyst between the proton exchange membrane and the gas diffusion layer, and with an anode catalyst between the proton exchange membrane and the porous transport layer.

8. The electrochemical device as recited in claim 7, wherein an outer peripheral edge of the proton exchange membrane is encapsulated by the thermoplastic film.

9. The electrochemical device as recited in claim 8, including a first film layer between the gas diffusion layer and the membrane electrode assembly and a second film layer between the porous transport layer and the membrane electrode assembly.

10. The electrochemical device as recited in claim 1, wherein an active area of the gas diffusion layer is thicker than a thickness of a portion of the sealed outer edge corresponding to the gas diffusion layer.

11. The electrochemical device as recited in claim 1, including a plate attached to a side of the porous transport layer that is opposite from the membrane electrode assembly such that the plate is formed as part of the electrochemical assembly that includes the sealed outer edge.

12. The electrochemical device as recited in claim 1, wherein the electrochemical device is a proton exchange membrane water electrolyzer.

13. A method of forming at least a portion of an electrochemical device comprising:
positioning a gas diffusion layer on one side of a membrane electrode assembly;
positioning a porous transport layer on an opposite side of the membrane electrode assembly; and
impregnating outer peripheral edges of the gas diffusion layer and the porous transport layer with a thermoplastic film to form an electrochemical assembly with a sealed outer edge.

14. The method as recited in claim 13, including providing the electrochemical assembly with at least one reinforcement, wherein:
the at least one reinforcement is provided in the outer peripheral edge of the porous transport layer, and/or
the at least one reinforcement is provided in the outer peripheral edge of the gas diffusion layer.

15. The method as recited in claim 13, wherein the membrane electrode assembly comprises a proton exchange membrane with a cathode catalyst between the proton exchange membrane and the gas diffusion layer, and with an anode catalyst between the proton exchange membrane and the porous transport layer, the method including:
encapsulating an outer peripheral edge of the proton exchange membrane with the thermoplastic film.

16. The method as recited in claim 15, including:
placing a first thermoplastic film layer between the gas diffusion layer and the membrane electrode assembly;
placing a second thermoplastic film layer between the porous transport layer and the membrane electrode assembly; and
heating and compressing outer peripheral edges of the gas diffusion layer, membrane electrode assembly, porous transport layer, and first and second thermoplastic film layers to form the electrochemical assembly.

17. The method as recited in claim 16, including, prior to the step of heating and compressing:
placing a first release film layer between a first platen and the gas diffusion layer;
placing a second release film layer between a second platen and the porous transport layer; and
releasing the assembly from the first platen and the second platen once the heating and compressing has been completed.

18. The method as recited in claim 13, including placing the electrochemical assembly on one or more bi-polar plates or separator plates.

19. The method as recited in claim 18, including forming flow ports through outer peripheral edges of the electrochemical assembly dimensioned to communicate fluid to corresponding ports in the one or more bi-polar or separator plates.

20. The method as recited in claim 13, including forming the thermoplastic film to include a plurality of support ribs that establish a plurality of flow channels.
